(19) United States
(12) Patent Application Publication
(10) Pub. No.: US 2006/0120843 A1
(43) Pub. Date: Jun. 8, 2006

(54) Apparatus for moving a load between lowered and inclined positions

(76) Inventor: John Haren, Jackson, MI (US)

Correspondence Address: Law Offices of John Chupa and Associates, PC;Suite 50, 28535 Orchard Lake Road, Farmington Hills, MI, 48334, US

(21) Appl. No.: 10/988,206

(22) Filed: Nov. 12, 2004

(51) Int. Cl. B60P 1/04

(52) U.S. Cl. 414/469

(57) ABSTRACT

The specification discloses an apparatus for moving a load between lowered and inclined positions, the apparatus comprising a load-carrying body having a center of gravity, the load-carrying body pivotally supported on a base for selective pivotal movement between a lowered position and an inclined position by a four-pivot axis linkage mechanism comprising at least first and second pivotal linkages. The linkage mechanism carries the load-carrying body rearwardly in relation to the base along a path of travel between fully lowered, intermediate, and fully inclined positions of the load-carrying body, along which path of travel the center of gravity of the load-carrying body is lowered between the fully lowered and intermediate positions thereof, and raised between the intermediate and fully inclined positions thereof.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### FIELD OF THE INVENTION

The present invention pertains generally to apparatus for moving loads between lowered and inclined positions, and more specifically to such an apparatus comprising a load-carrying body pivotally supported on a base for selective pivotal movement between a lowered position and an inclined position by a four-pivot axis linkage mechanism comprising at least first and second pivotal linkages.

### BACKGROUND OF THE INVENTION

Dumping vehicles have long been known as a means of moving cargo, including refuse such as dirt, sand, etc., from one location to another. It has also long been known that a quick way to discharge the contents of a loaded dumping vehicle is to move the load-containing body to an inclined position, thus causing the contents to move downwardly along the inclined body by the force of gravity. Most essentially, the means for accomplishing inclined positioning of the load body comprise a pivotal connection between that body and a supporting framework, and means for selectively pivoting the cargo body between lowered and inclined positions thereof. Such means for selective pivoting are known to include manually operable means as well as powered means including, for example, hydraulic mechanisms. An exemplary dumping vehicle comprising powered means for the inclined positioning of the load body is shown in Day, U.S. Pat. No. 2,542,799.

Over the years, various mechanisms have been devised for pivotally connecting a load body to a supporting framework in a dumping vehicle. Inter alia, these have included the mechanism of Frazier, U.S. Pat. No. 1,658,236, which discloses a dumping wagon having an automatic dumping body connected to a frame by a double toggle joint comprising a plurality of pivotal links. As specified in that patent, the double toggle joint includes a pair of forward pivotal links disposed just ahead of the center of gravity of the dumping body, and a pair of pivotal links disposed rearward of the center of gravity. Both pairs of links are pivotally connected to the frame in coplanar pivot axes. According to the disclosure of Frazier, the foregoing arrangement results in the automatic movement of the dumping body to the inclined position thereof when a load is carried in the dumping body, and, conversely, automatic movement of the empty dumping body to the lowered position thereof.

Notwithstanding this and other modifications to the basic mechanism for inclining a cargo body in a dumping vehicle, there has not, to date, been provided a simple mechanism for facilitating the movement of a load between lowered and inclined positions under conditions where the relative force required to move a load-carrying body to the inclined position has been significantly reduced for both manual and powered inclining means.

### SUMMARY OF THE DISCLOSURE

The present invention addresses and solves the problems discussed above, and encompasses other features and advantages, by providing an apparatus comprising a load-carrying body having a center of gravity, the load-carrying body pivotally supported on a base for selective pivotal movement between a lowered position and an inclined position by a four-pivot axis linkage mechanism comprising at least first and second pivotal linkages. The apparatus is characterized by a fully lowered position of the load-carrying body, wherein the center of gravity of the load-carrying body is positioned approximately above the at least first linkage, a fully inclined position of the load-carrying body, wherein the entire load-carrying body is shifted rearwardly in relation to the base and the center of gravity of the load-carrying body is positioned rearwardly of both of the at least first and second pivotal linkages, and an intermediate position, wherein the center of gravity of the load-carrying body is positioned intermediate of the at least first and second linkages. The linkage mechanism is operative to carry the load-carrying body rearwardly in relation to the base along a path of travel between the fully lowered, intermediate, and fully inclined positions of the load-carrying body, during which path of travel the center of gravity of the load-carrying body is lowered between the fully lowered and intermediate positions thereof, and raised between the intermediate and fully inclined positions thereof. In this manner, the present invention functions to utilize the energy of a load to move the cargo body to the inclined position thereof, while dissipating excess energy.

According to one feature hereof, the first pivotal linkage comprises at least one pivot arm having a fixed first length defined between upper and lower ends, the upper end of the at least one pivot arm being connected to the base for pivotal movement relative thereto about a first pivot axis, and the lower end of the at least one pivot arm being pivotally connected to the body for pivotal movement relative thereto about a second pivot axis. The second pivotal linkage comprises at least one pivot arm having a fixed second length defined between upper and lower ends, the upper end of the at least one pivot arm being connected to the base for pivotal movement relative thereto about a third pivot axis, and the lower end of the at least one pivot arm being pivotally connected to the body for pivotal movement relative thereto about a fourth pivot axis. The first length of the at least one pivot arm of the first pivotal linkage is greater than the second length of the at least one pivot arm of the second pivotal linkage, the first pivot axis is defined vertically above the third pivot axis, and the first pivotal linkage is positioned closer to the front end of the body than the second pivotal linkage.

According to another feature of this invention, the load body further comprises downwardly extending, laterally spaced-apart struts, each of the struts defining one of the second and fourth pivot axes.

According to still another feature hereof, a reinforcing member is provided which extends between the spaced-apart struts, providing torsional rigidity thereto.

Per yet another feature of the present invention, means are provided for assisting the powered or manual movement of the body between the lowered and inclined positions thereof. Such means may include, by way of non-limiting example, a manually graspable arm provided on the cargo body, an hydraulic piston, a powered or manually operable jack-screw, etc.

According to one feature of this invention, the base comprises a pair of laterally spaced-apart frame members, the at least one pivot arm of the first pivotal linkage comprises a substantially planar, rigid member disposed between the spaced-apart frame members, and the at least one pivot arm of the second pivotal linkage comprises a substantially planar, rigid member disposed between the spaced-apart frame members.

Per still a further feature hereof, the apparatus comprises a wheeled base, according to which the invention may be employed as a dumping vehicle.

### BRIEF DESCRIPTION OF THE DRAWINGS

FIG. 1 is a lateral elevation depicting an exemplary dumping vehicle incorporating the apparatus of the present invention;

FIG. 2 is an exploded perspective view of the several elements comprising the linkage mechanism of the inventive apparatus;

FIG. 3 is a lateral elevation view of a strut member according to the illustrated embodiment of the present invention;

FIGS. 4A and 4B comprise detailed longitudinal cross-sections of the dumping vehicle of FIG. 1 in illustration of the operation of the present inventive apparatus in the movement of a cargo body between lowered and inclined positions; and

FIGS. 5A-5C depict the dumping vehicle of FIG. 1 in illustration of the several positions of the cargo body in movement from the lowered to inclined positions thereof, each of the figures being interconnected by an imaginary line depicting the path of travel of the cargo body center of gravity through the range of movement thereof.

### WRITTEN DESCRIPTION

Referring now to the drawings, wherein like or corresponding numerals indicate like or corresponding parts throughout the several views, the present invention will be seen to most generally comprise an apparatus for facilitating the movement of a load between lowered and inclined positions.

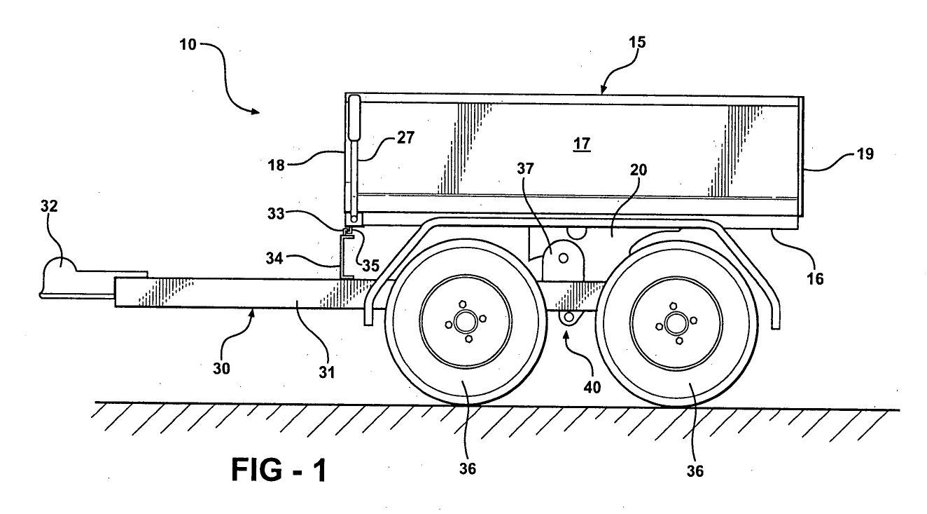

More particularly, and with reference being had first to FIG. 1, wherein the apparatus of the present invention is shown in combination with one variety of dumping vehicle 10, and more particularly a dumping trailer, and according to which the apparatus may be employed to facilitate the movement of a load carrying body 15 between lowered (FIG. 1) and inclined (not depicted in FIG. 1) positions, the apparatus comprises a base 30 on which the load body 15 is pivotally supported by a modified four-bar style linkage mechanism 40 (indicated only approximately in FIG. 1) for selective pivotal movement between the lowered and inclined positions.

But while the present invention is shown in use in a dumping trailer, it will be appreciated from this written specification and the accompanying drawings that the apparatus of this invention may be adapted to numerous other operational environments where it is desired to facilitate the selective assisted movement of a load from a lowered to an inclined position. Thus, by way of non-limiting example, the apparatus may be mounted as a bucket on an earth-moving vehicle, such as a front-end loader, may be incorporated into a conveyor system employed to transport loads from one place to another, or may be incorporated into powered vehicles, such as a dump truck.

Still referring to FIG. 1, the load body 15 is shown to comprise a container for holding a desired load, the container defined by a bottom 16, sidewalls 17, and a forward end-wall 18. A rearward end-wall 19 may also be provided, and may further take the form of a selectively moveable gate (not shown), as is known in the art. Struts 20 project downwardly from the bottom 16 of load body 15 to define points of securement for the linkage mechanism 40, as hereafter described. These various elements may be defined in a monolithic structure or formed separately and thereafter assembled by known means. In the illustrated embodiment, body 15 is fashioned from a suitably strong material, such as metal, according to conventional means. Of course, the design and construction of the body 15 need not be so limited, and may be adapted to numerous conventional designs as necessary.

Base 30 may likewise take a number of forms. In the illustrated embodiment of this invention, base 30 comprises a rigid metal, trailer-style framework including, in conventional fashion, a pair of frame members 31 which are laterally spaced-apart and disposed approximately parallel to each other proximate the rear half of the framework. These frame members 31 are angled inwardly and come together towards the front of the framework where, in the illustrated embodiment, a trailer hitch 32 is provided for securing the base 30 to a conveying vehicle, such as an automobile. One or more transverse frame members (not depicted) spanning the frame members 31 may be provided for rigidity, as known. Proximate the forward end-wall 18 of the cargo body 15 the base 30 is provided with the striker portion 33 of a latch mounted upon an upwardly projecting support 34. In corresponding position on the lower portion of the forward end-wall 19 of the load body 15 is disposed the locking portion 35 of the latch. As shown, the base 30 includes one or more wheels 36, either free-spinning or motor-driven, as desired, connected to the framework 31.

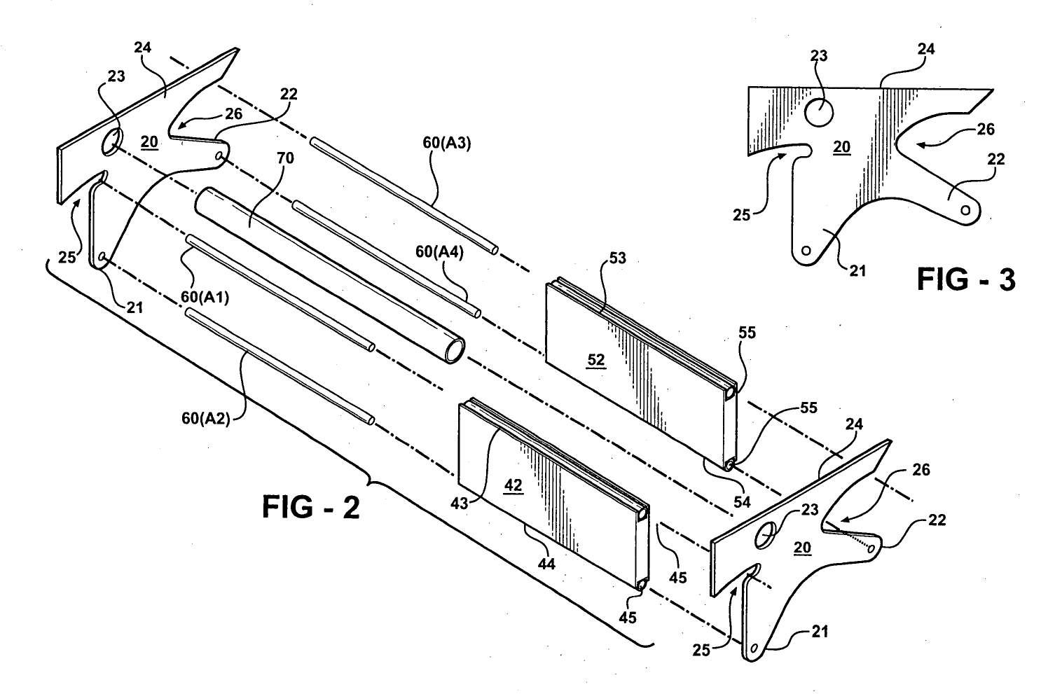

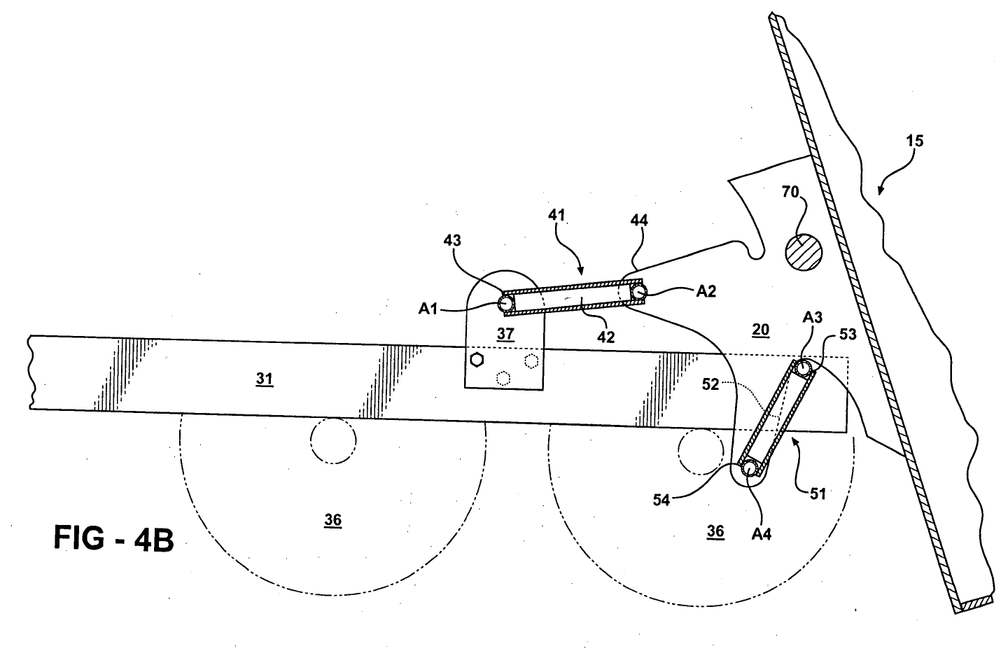

Referring now to FIGS. 2, 4A and 4B, the linkage mechanism 40 will be seen to comprise, most generally, a four-pivot axis linkage mechanism including spaced-apart first 41 and second 51 pivotal linkages. This mechanism may be characterized as defining a kind of modified four-bar linkage. The first pivotal linkage 41 comprises at least one pivot arm 42 having a fixed first length defined between upper 43 and lower 44 ends. The upper end 43 of the at least one pivot arm 42 is connected to the base 30 for pivotal movement relative thereto about a first pivot axis A1, and the lower end 44 of the at least one pivot arm is pivotally connected to the body 15 for pivotal movement relative thereto about a second pivot axis A2. The second pivotal linkage 51 comprises at least one pivot arm 52 having a fixed second length defined between upper 53 and lower 54 ends. The upper end 53 of the at least one pivot arm 52 is connected to the base 30 for pivotal movement relative thereto about a third pivot axis A3 defined vertically below the pivot axis A1, and the lower end 54 of the at least one pivot arm 52 is pivotally connected to the body 15 for pivotal movement relative thereto about a fourth pivot axis A4. In the illustrated embodiment, the horizontal distance between the first A1 and third A3 pivot axes is approximately 26 inches.

As best depicted in FIGS. 4A and 4B, the first length of the at least one pivot arm 42 is slightly greater than the second length of the at least one pivot arm 52. More particularly, in the illustrated embodiment the first length of the at least one pivot arm 42 is approximately 11 inches, while the second length of the at least one pivot arm 52 is approximately 9½ inches.

Pivot arms 42 and 52 are, according to the illustrated embodiment, defined by rigid, substantially planar shear plates oriented transversely of the longitudinal axis of the base 30. Pivot arms 42 and 52 are formed of a suitable material, such as, for instance, metal, so as to resist planar stresses. In the illustrated form, each such pivot arm 42, 52 is particularly defined by a pair of sheets of suitably strong metal, such as steel plate, one of which plates is bent proximate its lateral ends to define reinforcing end-walls, as shown, and to provide exact spacing against a trim edge for sleeves or tubes 45, 55 described elsewhere herein. But while this configuration of the pivot arms 42 and 52 is advantageous in providing pivoting linkages well-suited to withstanding flexing, the present invention is not intended to be so limited. Thus, by way of example, it is contemplated that the at least first and second pivotal linkages 41 and 51 may comprise four separate pivot arms, two disposed on each of the two opposing frame members 31 and each pivoting about one of the pair of pivot axes A1, A2 or A3, A4 in a more traditional four-bar style linkage.

In order to facilitate pivotal attachment to the body 15 and base 30 according to the illustrated embodiment, each pivot arm 42 and 52 is provided at the opposite upper and lower ends (43, 44 and 53, 54, respectively) thereof with a sleeve or tube 45, 55, respectively, each such sleeve having a bore therethrough dimensioned to rotatably receive therein one of the four axles or rods 60 defining pivot axes A1-A4.

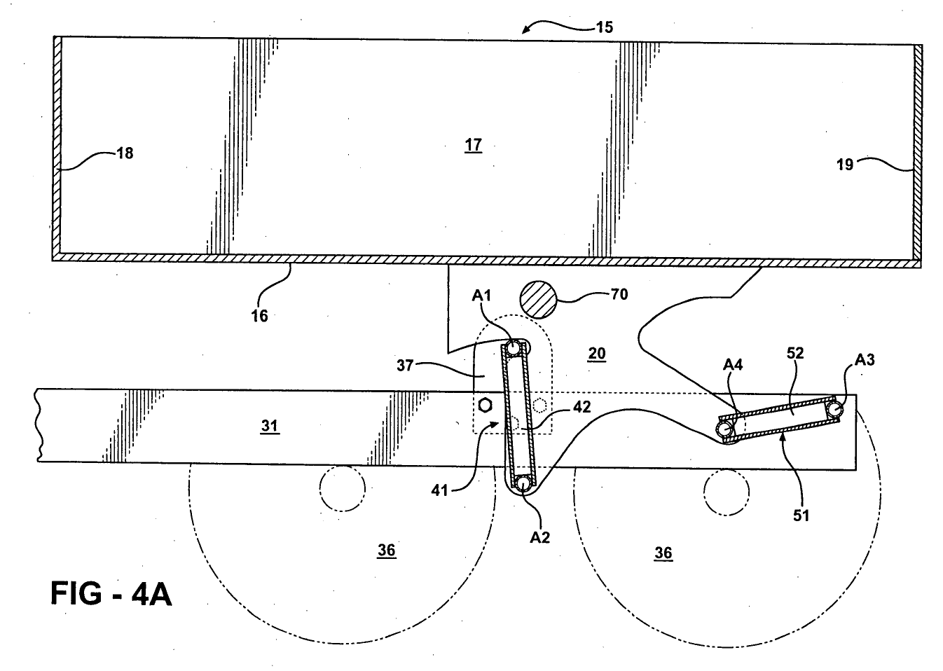

Referring also to FIG. 3, interconnection of the first 41 and second 51 linkages to the load body 15 is, per the illustrated embodiment, accomplished via a pair of identical, spaced-apart, rigid struts 20 depending from the bottom 16 of the load body 15. As shown, each strut 20 is generally planar, being fashioned from a suitably strong material, such as, for example, steel plate. Each strut 20 includes a pair of arms 21, 22 each defining a point of pivotal attachment to the lower end of one of the pivot arms 41 and 51, respectively. In the illustrated embodiment, these points of pivotal attachment are spaced apart by approximately 17 inches. The struts 20 may further be interconnected by a torsion member 70 to provide torsional rigidity and resist unwanted flexing of the struts 20, and therefore body 15, under load-bearing conditions. Though not intended to be limiting of this invention, the torsion member 70 may comprise a tube secured, for instance by welding, to cut outs 23 provided through each strut 20. A top length 24 of each strut 20 provides a point of securement to the load body 15, such as by riveting, welding, or fastening with bolts or the like, where the struts are not formed integrally therewith. To facilitate the full range of pivotal motion of the load body 15, described elsewhere herein, each strut 20 further includes oppositely opening slots 25, 26 dimensioned to freely receive therein the outer diameter of one of the tubes 45, 55, respectively, throughout the range of motion of the struts 20.

Referring specifically to FIGS. 4A and 4B, the structural interrelationship of the linkage assembly 40, load body 15 and base 30 will be better understood. As shown, the two pivot axles 60 defining pivot axes A1 and A3 are secured at opposite ends thereof to the spaced-apart frame members 31 of base 30, while the two pivot axles 60 defining pivot axes A2 and A4 are secured at the opposite ends thereof to the points of pivotal attachment provided on the pair of arms 21, 22. This may be accomplished by any known means, including, for instance, bolts.

The pivot axle 60 defining pivot axis A3 is secured to spaced-apart frame members 31. The first pivot axis A1 is defined vertically above the third pivot axis A3. In the illustrated embodiment more particularly, the first pivot axis A1 is defined approximately 3½ inches above the third pivot axis A3. To achieve the foregoing configuration, one of a pair of rigid mounting plates 37 may be fixed to each of the frame members 31 as depicted, each mounting plate 37 defining a point of attachment for an end of the pivot axle 60 defining the pivot axis A1. Of course, those of skill in the art will, with the benefit of this disclosure, appreciate that alternate means of positioning the first pivot axis A1 above the third pivot axis A3 may be employed. Thus, for instance, it is contemplated that pivot axle 60 defining the axis A1 may be secured directly to the frame members 31, with the mounting plate 37 depending downwardly therefrom to provide a vertically lower point of attachment for the pivot axle defining the pivot axis A3. And while the mounting plates 37 are shown as separate elements affixed to the frame members 31, it is contemplated that the same could be formed integrally with other components of the base 30.

As desired, the apparatus of this invention may include means for assisting the manual or powered movement of the body 15 between the lowered and inclined positions thereof. According to the illustrated embodiment, depicting manual movement means, there may, for example, be provided an arm 27 connected to the load body 15 and projecting therefrom. As will be appreciated, the arm 27 is of suitable size and shape to be manually grasped by a user, who may then use the same to effect the pivotal movement of the load body 15. Optionally, the arm 27 may further be operatively connected to the locking portion 35 of the aforementioned latch in order to selectively effect the locking engagement thereof with the striking portion 33, as well as locking and unlocking the tail gate, if provided. Alternatively, powered means may be provided. Such means may, for instance, comprise an inclined linear actuator provided between the base 30 and load body 15, a scissors mechanism operating between base 30 and load body 15, straight line generators designed to amplify the stroke of a linear actuator, etc. In addition, a linear actuator may be attached between pivot arms 41 and 51 to provide assistance by reacting one arm against the other.

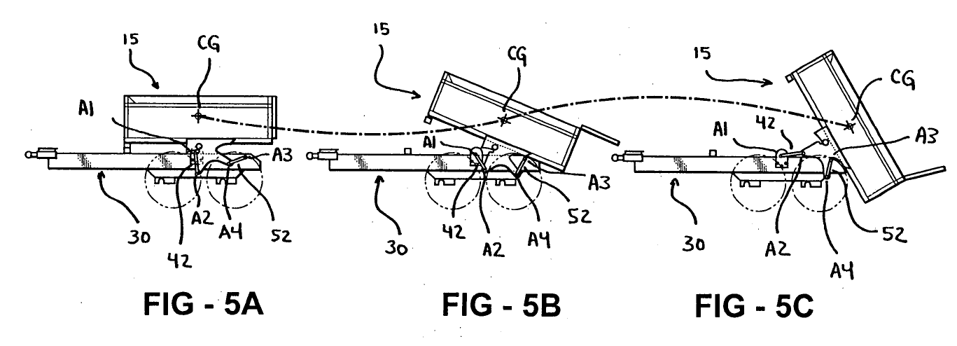

Turning now to FIGS. 4A, 4B, and 5A-5C, operation of the present invention will be more fully understood.

Referring first to FIGS. 4A and 5A, which depict the load body 15 in a lowered position with the latch (not shown) engaged to keep the load body 15 secured against pivotal movement, the load body 15 is supported on the base 30 by the first pivot arm 42, which is oriented substantially vertically with both pivot axis A1 and A2 generally aligned with the center of the load body 15. Upon releasing the latch, the load body 15 is free to be pivotally moved to the inclined position thereof. At the beginning of this movement, immediately following release of the latch, the load body 15 tends naturally to a slightly inclined, first neutral position (not depicted) by virtue of the linkage mechanism 40 arrangement as shown and described, according to which the center of gravity of the load body 15 is positioned slightly behind the pivot arm 42. With the mass of a load contained in the load body 15, and with the application of force to displace the load body 15 from the fully lowered position thereof, the entire load body 15 will, following release of the latch, shift rearwardly and downwardly along the arcuate path of travel defined by the second pivot arm 52 about axis A3, the load body 15 further pivoting about the pivot axis A4. Simultaneously, the load body 15 pivots about pivot axis A2 as the pivot arm 42 is drawn rearwardly along the arcuate path of travel defined about the pivot axis A1. This movement results in the development of force as the combined mass of the cargo body 15 and load accelerates through the downward movement of the second pivot arm 52. As this movement continues, the load body 15 is carried through an intermediate position (FIG. 5B) characterized in that the center of gravity CG of the load body 15 is positioned in between the first 42 and second 52 pivot arms. As depicted best in FIGS. 5A and 5B, the center of gravity CG of the load body 15 is lowered along the path of travel between the fully lowered (FIG. 5A) and intermediate (FIG. 5B) positions of the load body 15.

The intermediate position (FIG. 5B) of the load body 15 defines that point in the path of travel of the load body 15 between the fully lowered and inclined positioned thereof where shifting motion of the load within the load body 15 is anticipated. Accordingly, and as best shown between FIGS. 5B and 5C, the intermediate position is defined at that point in the pivotal movement of the first 42 and second 52 pivot arms where further rearward pivotal movement of the second pivot arm 52 about axis A3 ceases in favor of forward pivotal movement about the same axis A3 as the first pivot arm 42 continues to pivot upwardly about axis A1, drawing the pivot arm 52 forward. By this design, the center of gravity CG of the cargo body 15 rises between the intermediate (FIG. 5B) and fully inclined (FIG. 5C) positions of the cargo body 15 to compensate for the increased force created by the shifting—and, thus, accelerating—load proximate the intermediate position.

In the fully inclined (FIGS. 4A and 5C) position of the cargo body 15, it will be seen that the center of gravity CG of the cargo body 15 returns to approximately the same vertical position as in the fully lowered state (FIG. 5A). In the fully inclined position, however, it will also be seen that the center of gravity CG is positioned rearwardly of the first 42 and second 52 pivot arms. Accordingly, the cargo body 15 defines a second neutral position in the fully inclined position thereof.

As shown best in FIG. 4B, the first pivot arm 42 is slightly upwardly angled in the fully inclined position of the cargo body 15. By this arrangement, any unexpended force from the movement of the cargo body 15 to the fully inclined position is expended through the continued upward, counter-clockwise movement of the pivot arm 42 about the pivot axis A1, and the concomitant clockwise movement of the pivot arm 52 about the pivot axis A3. This movement carries the cargo body 15 upwardly and forward, bringing the center of gravity CG of the cargo body 15 upwards.

Those skilled in the art will of course appreciate that while pivoting movement of the cargo body 15 is described in relation to the pivot axes A1-A4, the first 41 and second 51 linkages are interdependent and function to in fact move the cargo body 15 about an infinite series of imaginary points.

By virtue of the foregoing arrangement, it will be appreciated that the apparatus of this invention facilitates the movement of a load from a lowered to an inclined position with significantly less— or, in the case of a balanced load, even no—force than is required to move a comparable load from a lowered to an inclined position in a dump vehicle wherein the load body is simply pivotally connected to a supporting frame at a single pivot axis.

It will be appreciated from the above disclosure that the present invention improves upon the prior art by providing simple mechanism for facilitating the selective assisted movement of a load between lowered and inclined positions under conditions where the relative force required to move a load-containing cargo body to the inclined position has been significantly reduced for both manual and powered pivoting means.

Of course, the foregoing is merely illustrative of the present invention, and those of ordinary skill in the art will appreciate that many additions and modifications to the present invention, as set out in this disclosure, are possible without departing from the spirit and broader aspects of this invention as defined in the appended claims. For instance, it will be appreciated that any of the absolute distances of the linkage mechanism provided herein are not intended to be limiting of the present invention, and may be modified without departing from the spirit and broader aspects hereof.

1. An apparatus for moving a load between lowered and inclined positions, the apparatus comprising:
a body for carrying a load, the body having a front end and a rear end and being pivotally supported on a base by a linkage mechanism for selective pivotal movement between a lowered position and an inclined position;
said linkage mechanism including spaced-apart first and second pivotal linkages, said first pivotal linkage comprising at least one pivot arm having a fixed first length defined between upper and lower ends, the upper end of the at least one pivot arm being connected to the base for pivotal movement relative thereto about a first pivot axis, and the lower end of the at least one pivot arm being pivotally connected to the body for pivotal movement relative thereto about a second pivot axis, and said second pivotal linkage comprising at least one pivot arm having a fixed second length defined between upper and lower ends, the upper end of the at least one pivot arm being connected to the base for pivotal movement relative thereto about a third pivot axis, and the lower end of the at least one pivot arm being pivotally connected to the body for pivotal movement relative thereto about a fourth pivot axis;
wherein said first length of said at least one pivot arm of said first pivotal linkage is greater than said second length of said at least one pivot arm of said second pivotal linkage;
wherein said first pivot axis is defined vertically above said third pivot axis; and
wherein further said first pivotal linkage is positioned closer to the front end of said body than said second pivotal linkage.

2. The apparatus of claim 1, wherein said load body further comprises downwardly extending, laterally spaced-apart struts, each of said struts defining one of the second and fourth pivot axes.

3. The apparatus of claim 2, further comprising a reinforcing member extending between said spaced-apart struts.

4. The apparatus of claim 1, further comprising means for assisting the powered movement of the body between the lowered and inclined positions thereof.

5. The apparatus of claim 1, further comprising means for assisting the manual movement of the body between the lowered and inclined positions thereof.

6. The apparatus of claim 1, wherein said base comprises a pair of laterally spaced-apart frame members, said at least one pivot arm of said first pivotal linkage comprises a substantially planar, rigid member disposed between said spaced-apart frame members, and said at least one pivot arm of said second pivotal linkage comprises a substantially planar, rigid member disposed between said spaced-apart frame members.

7. The apparatus of claim 1, wherein said base comprises a wheeled base.

8. An apparatus for moving a load between lowered and inclined positions, the apparatus comprising:
a load-carrying body having a center of gravity, the load-carrying body pivotally supported on a base for selective pivotal movement between a lowered position and an inclined position by a four-pivot axis linkage mechanism comprising at least first and second pivotal linkages;
wherein the linkage mechanism is operative to carry the load-carrying body rearwardly in relation to the base along a path of travel between fully lowered, intermediate, and fully inclined positions of the load-carrying body; and
wherein the center of gravity of the load-carrying body is lowered between the fully lowered and intermediate positions thereof, and the center of gravity of the load-carrying body rises between the intermediate and fully inclined positions thereof.

9. The apparatus of claim 8, wherein:
said first pivotal linkage comprises at least one pivot arm having a fixed first length defined between upper and lower ends, the upper end of the at least one pivot arm being connected to the base for pivotal movement relative thereto about a first pivot axis, and the lower end of the at least one pivot arm being pivotally connected to the body for pivotal movement relative thereto about a second pivot axis;
said second pivotal linkage comprises at least one pivot arm having a fixed second length defined between upper and lower ends, the upper end of the at least one pivot arm being connected to the base for pivotal movement relative thereto about a third pivot axis, and the lower end of the at least one pivot arm being pivotally connected to the body for pivotal movement relative thereto about a fourth pivot axis;
said first length of said at least one pivot arm of said first pivotal linkage is greater than said second length of said at least one pivot arm of said second pivotal linkage;
said first pivot axis is defined vertically above said third pivot axis; and
said first pivotal linkage is positioned closer to the front end of said body than said second pivotal linkage.

10. The apparatus of claim 9, wherein said load-carrying body further comprises downwardly extending, laterally spaced-apart struts, each of said struts defining one of the second and fourth pivot axes.

11. The apparatus of claim 10, further comprising a reinforcing member extending between said spaced-apart struts.

12. The apparatus of claim 8, further comprising means for assisting the powered movement of the body between the lowered and inclined positions thereof.

13. The apparatus of claim 8, further comprising means for assisting the manual movement of the body between the lowered and inclined positions thereof.

14. The apparatus of claim 9, wherein said base comprises a pair of laterally spaced-apart frame members, said at least one pivot arm of said first pivotal linkage comprises a substantially planar, rigid member disposed between said spaced-apart frame members, and said at least one pivot arm of said second pivotal linkage comprises a substantially planar, rigid member disposed between said spaced-apart frame members.

15. An apparatus for moving a load between lowered and inclined positions, the apparatus comprising:
a load-carrying body having a center of gravity, the load-carrying body pivotally supported on a base for selective pivotal movement between a lowered position and an inclined position by a four-pivot axis linkage mechanism comprising at least first and second pivotal linkages;
the apparatus being characterized by a fully lowered position of the load-carrying body, wherein the center of gravity of the load-carrying body is positioned approximately above the at least first linkage, a fully inclined position of the load-carrying body, wherein the entire load-carrying body is shifted rearwardly in relation to the base and the center of gravity of the load-carrying body is positioned rearwardly of both of the at least first and second pivotal linkages, and an intermediate position, wherein the center of gravity of the load-carrying body is positioned intermediate of the at least first and second linkages; and
wherein the center of gravity of the load-carrying body is lowered between the fully lowered and intermediate positions thereof, and the center of gravity of the load-carrying body rises between the intermediate and fully inclined positions thereof.

16. The apparatus of claim 15, wherein:
said first pivotal linkage comprises at least one pivot arm having a fixed first length defined between upper and lower ends, the upper end of the at least one pivot arm being connected to the base for pivotal movement relative thereto about a first pivot axis, and the lower end of the at least one pivot arm being pivotally connected to the body for pivotal movement relative thereto about a second pivot axis;
said second pivotal linkage comprises at least one pivot arm having a fixed second length defined between upper and lower ends, the upper end of the at least one pivot arm being connected to the base for pivotal movement relative thereto about a third pivot axis, and the lower end of the at least one pivot arm being pivotally connected to the body for pivotal movement relative thereto about a fourth pivot axis;
said first length of said at least one pivot arm of said first pivotal linkage is greater than said second length of said at least one pivot arm of said second pivotal linkage;
said first pivot axis is defined vertically above said third pivot axis; and
said first pivotal linkage is positioned closer to the front end of said body than said second pivotal linkage.

17. The apparatus of claim 16, wherein said load body further comprises downwardly extending, laterally spaced-apart struts, each of said struts defining one of the second and fourth pivot axes.

18. The apparatus of claim 17, further comprising a reinforcing member extending between said spaced-apart struts.

19. The apparatus of claim 15, further comprising means for assisting the powered movement of the body between the lowered and inclined positions thereof.

20. The apparatus of claim 15, further comprising means for assisting the manual movement of the body between the lowered and inclined positions thereof.

21. The apparatus of claim 16, wherein said base comprises a pair of laterally spaced-apart frame members, said at least one pivot arm of said first pivotal linkage comprises a substantially planar, rigid member disposed between said spaced-apart frame members, and said at least one pivot arm of said second pivotal linkage comprises a substantially planar, rigid member disposed between said spaced-apart frame members.

22. The apparatus of claim 15, wherein said base comprises a wheeled base.
